(19) United States
(12) Patent Application Publication
(10) Pub. No.: US 2018/0152050 A1
(43) Pub. Date: May 31, 2018

(54) APPARATUS FOR TRANSMITTING POWER WIRELESSLY

(71) Applicant: Samsung Electro-Mechanics Co., Ltd., Suwon-si (KR)

(72) Inventors: Tae Seok KO, Suwon-si (KR); Ji Hoon KIM, Suwon-si (KR)

(73) Assignee: Samsung Electro-Mechanics Co., Ltd.

(21) Appl. No.: 15/498,510

(22) Filed: Apr. 27, 2017

(30) Foreign Application Priority Data
Nov. 29, 2016 (KR) 10-2016-0160801
Dec. 28, 2016 (KR) 10-2016-0181234

(51) Int. Cl. H02J 50/12; H02J 7/02; H02J 50/60; H01F 38/14; G06K 7/10

(52) U.S. Cl. CPC H02J 50/12; H02J 7/025; G06K 7/10207; H01F 38/14; H02J 50/60

(57) ABSTRACT

An apparatus for transmitting power wirelessly includes a transmission coil circuit including a single coil including a plurality of turns; a high power transmitter configured to transmit a high power transmission signal for transmitting first power through the transmission coil circuit; a low power transmitter configured to transmit a low power transmission signal for transmitting second power lower than the first power through the transmission coil circuit; and a switching circuit configured to electrically connect either the high power transmitter or the low power transmitter to the transmission coil circuit in response to operations of the high power transmitter and the low power transmitter.

### CROSS-REFERENCE TO RELATED APPLICATIONS

This application claims the benefit under 35 USC 119(a) of Korean Patent Application Nos. 10-2016-0160801 filed on Nov. 29, 2016, and 10-2016-0181234 filed on Dec. 28, 2016, in the Korean Intellectual Property Office, the entire disclosures of which are incorporated herein by reference for all purposes.

### BACKGROUND

### 1. Field

The following description relates to an apparatus for transmitting power wirelessly.

### 2. Description of Related Art

As wireless technology has been developed, various wireless functions, ranging from the transmission of data to the transmission of power, have been enabled. In particular, wireless power transmission technology enabling an electronic device to be charged with power even without any contact between an electronic device and an apparatus for transmitting power wirelessly has recently been developed.

Wireless power transmission technology allows high power to be transmitted wirelessly. Thus, in a case in which foreign objects, rather than a device to be charged, are present, a problem in which high power causes damage or other problems may occur. Due to this fact, it is important to detect foreign objects.

In addition, a demand for miniaturization and a reduction in prices of apparatuses for transmitting power wirelessly, as well as a demand for various technologies described above, is also increasing.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an apparatus for transmitting power wirelessly includes a transmission coil circuit including a single coil including a plurality of turns; a high power transmitter configured to transmit a high power transmission signal for transmitting first power through the transmission coil circuit; a low power transmitter configured to transmit a low power transmission signal for transmitting second power lower than the first power through the transmission coil circuit; and a switching circuit configured to electrically connect either the high power transmitter or the low power transmitter to the transmission coil circuit in response to operations of the high power transmitter and the low power transmitter.

The high power transmission signal may include any one or any combination of any two or more of a foreign object detection signal for detecting a foreign object, a determination signal for determining whether the foreign object is an apparatus for receiving power wirelessly, and a power transmission signal for wirelessly transmitting power to the apparatus for receiving power wirelessly.

The low power transmission signal may include a wireless tag detection signal for reading a wireless tag.

The switching circuit may include a switch configured to connect the single coil to either the high power transmitter or the low power transmitter; and a processor configured to control switching of the switch.

The apparatus for transmitting power wirelessly may further include a memory configured to store instructions; and the processor may be further configured to execute the instructions to configure the processor to control the switching of the switch.

The processor may include a switch controlling circuit configured to control the switching of the switch.

The switch controlling circuit may be further configured to electrically connect the transmission coil circuit to the low power transmitter in response to the wireless tag being determined to be present by the wireless tag detection signal.

The switch controlling circuit may be further configured to control the switch to alternately connect the high power transmitter to the single coil while the high power transmitter transmits the foreign object detection signal, and the low power transmitter to the single coil while the low power transmitter transmits the wireless tag detection signal.

The switch controlling circuit may include a data input interface configured to receive data from the high power transmitter and the low power transmitter; a high power execution detector configured to detect an execution state of the high power transmitter based on the data; a low power execution detector configured to detect an execution state of the low power transmitter based on the data; and a switch controller configured to control the switch to connect either the high power transmitter or the low power transmitter to the single coil in response to the execution state of the high power transmitter and the execution state of the low power transmitter.

The apparatus for transmitting power wirelessly may be configured to receive a predetermined level of direct current (DC) power from a power supply; the high power transmitter may include a first DC-DC converter configured to boost the DC power; and the low power transmitter may include a second DC-DC converter configured to step down the DC power.

The high power transmitter may further include an inverter configured to output alternating current (AC) power by performing a switching operation on an output of the first DC-DC converter, and a matching circuit connected to an output terminal of the inverter and including at least one capacitor; and the single coil and the at least one capacitor may form a resonant circuit.

The matching circuit may further include at least one switch; and the switching circuit may be further configured to control an operation of the at least one switch to control switching between the high power transmitter and the transmission coil circuit.

In another general aspect, an apparatus for transmitting power wirelessly includes a transmission coil circuit including a single coil including a plurality of turns; a high power transmitter configured to transmit a high power transmission signal for transmitting first power through the transmission coil circuit; a low power transmitter configured to transmit a low power transmission signal for transmitting second power lower than the first power through the transmission coil circuit; a first filter connected to an output terminal of the high power transmitter and configured to block signals having frequencies outside a frequency range of the high power transmitter; and a second filter connected to an output terminal of the low power transmitter and configured to block signals having frequencies outside a frequency range of the low power transmitter.

The high power transmitter may include a first direct current (DC)-DC converter configured to boost DC power received from a power supply; an inverter configured to output alternating current (AC) power by performing a switching operation on an output of the first DC-DC converter; and a processor configured to control the switching operation of the inverter.

The apparatus for transmitting power wirelessly may further include a memory configured to store instructions; and the processor may be further configured to execute the instructions to configure the processor to control the switching operation of the inverter.

The processor may include a high power transmission controller configured to control the switching operation of the inverter.

The high power transmission controller may be further configured to operate during a period during which the low power transmitter does not operate.

The high power transmission controller may be further configured to have operational priority over the transmission coil circuit and provide the low power transmitter with information indicating when the high power transmission controller is not operating.

The low power transmitter may include a second DC-DC converter configured to step down the DC power.

The high power transmission signal may include any one or any combination of any two or more of a foreign object detection signal for detecting a foreign object, a determination signal for determining whether the foreign object is an apparatus for receiving power wirelessly, and a power transmission signal for wirelessly transmitting power to the apparatus for receiving power wirelessly; and the low power transmission signal may include a wireless tag detection signal for reading a wireless tag.

In another general aspect, an apparatus for transmitting power wirelessly includes a transmission coil circuit including a single coil; a high power transmitter configured to output a high power transmission signal for transmitting first power through the transmission coil circuit; a low power transmitter configured to output a low power transmission signal for transmitting second power lower than the first power through the transmission coil circuit; and an access controller configured to enable the high power transmitter and the low power transmitter to alternately access the transmission coil circuit until a predetermined condition occurs.

The predetermined condition may be a presence of a wireless device subject to damage by the high power transmission signal; and the access controller may be further configured to enable only the low power transmitter to access the transmission coil circuit as long as the wireless device is present, and thereafter once again enable the high power transmitter and the low power transmitter to alternately access the transmission coil circuit until the predetermined condition occurs again.

The predetermined condition may be a presence of a wireless device configured to wirelessly receive power from the high power transmitter; and the access controller may be further configured to enable only the high power transmitter to access the transmission coil circuit as long as the wireless device configured to wirelessly receive power from the high power transmitter is present, and thereafter once again enable the high power transmitter and the low power transmitter to alternately access the transmission coil circuit until the predetermined condition occurs again.

The high power transmitter may include a first matching circuit configured to match the high power transmission signal to the transmission coil circuit; the low power transmitter may include a second matching circuit configured to match the low power transmission signal to the transmission coil circuit; either one or both of the first matching circuit and the second matching circuit include a switch configured to change a matching impedance of the either one or both of the first matching circuit and the second matching circuit; and the access controller may be further configured to control the switch in the either one or both of the first matching circuit and the second matching circuit to enable the high power transmitter and the low power transmitter to alternately access the transmission coil circuit until the predetermined condition occurs.

In another general aspect, an apparatus for transmitting power wirelessly includes a transmission coil circuit including a single coil; a high power transmitter configured to output a high power transmission signal for transmitting first power through the transmission coil circuit; a low power transmitter configured to output a low power transmission signal for transmitting second power lower than the first power through the transmission coil circuit; and an access controller configured to enable only the high power transmitter to access the transmission coil circuit until a predetermined condition occurs.

The predetermined condition may be a presence of a foreign object; and the access controller may be further configured to enable only the low power transmitter to access the transmission coil circuit to determine whether the foreign object is a wireless device subject to damage by the high power transmission signal.

The access controller may be further configured to prevent the high power transmitter from accessing the transmission coil circuit as long as the foreign object is present in response to a determination that the foreign object is a wireless device subject to damage by the high power transmission signal.

The access controller may be further configured to enable only the high power transmitter to access the transmission coil circuit to supply power wirelessly to the foreign object as long as the foreign object is present in response to a determination that the foreign object is not a wireless device subject to damage by the high power transmission signal.

Other features and aspects will be apparent from the following detailed description, the drawings, and the claims.

### BRIEF DESCRIPTION OF DRAWINGS

FIG. 1A is a view illustrating an example of an apparatus for transmitting power wirelessly.

FIG. 1B is a view illustrating another example of an apparatus for transmitting power wirelessly.

FIG. 2 is a block diagram illustrating an example of an apparatus for transmitting power wirelessly.

FIG. 3 is a block diagram illustrating an example of the apparatus for transmitting power wirelessly illustrated in FIG. 2.

FIG. 4 is a block diagram illustrating an example of a first operation of the apparatus for transmitting power wirelessly illustrated in FIG. 3.

FIG. 5 is a block diagram illustrating an example of a second operation of the apparatus for transmitting power wirelessly illustrated in FIG. 3.

FIG. 6 is a block diagram illustrating an example of the switch controlling circuit illustrated in FIG. 3.

FIG. 7 is a block diagram illustrating another example of the apparatus for transmitting power wirelessly illustrated in FIG. 2.

FIG. 8 is a block diagram illustrating another example of an apparatus for transmitting power wirelessly.

FIG. 9 is a block diagram illustrating an example of the apparatus for transmitting power wirelessly illustrated in FIG. 8.

FIGS. 10 to 12 are views illustrating examples of a transmission signal of an apparatus for transmitting power wirelessly.

FIG. 13 is a view illustrating an example in which a wireless tag is placed at different positions on an apparatus for transmitting power wirelessly.

FIG. 14 illustrates an example of a block diagram of a controller of an apparatus for transmitting power wirelessly.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of functions and constructions that are known in the art may be omitted for increased clarity and conciseness.

The features described herein may be embodied in different forms, and are not to be construed as being limited to the specific examples described herein. Rather, example described herein have been provided merely to illustrate some of the many possible ways of implementing the methods, apparatuses, and/or systems described herein that will be apparent after an understanding of the disclosure of this application.

The terminology used herein describes particular examples only, and the scope of the disclosure is not limited by this terminology. As used herein, the singular forms “a,” “an,” and “the” are intended to include the plural forms as well, unless the context clearly indicates otherwise. The terms “comprises,” “includes,” and “has” and their various forms, when used in this specification, specify the presence of stated features, numbers, operations, members, elements, and/or combinations thereof, but do not preclude the presence or addition of one or more other features, numbers, operations, members, elements, and/or combinations thereof.

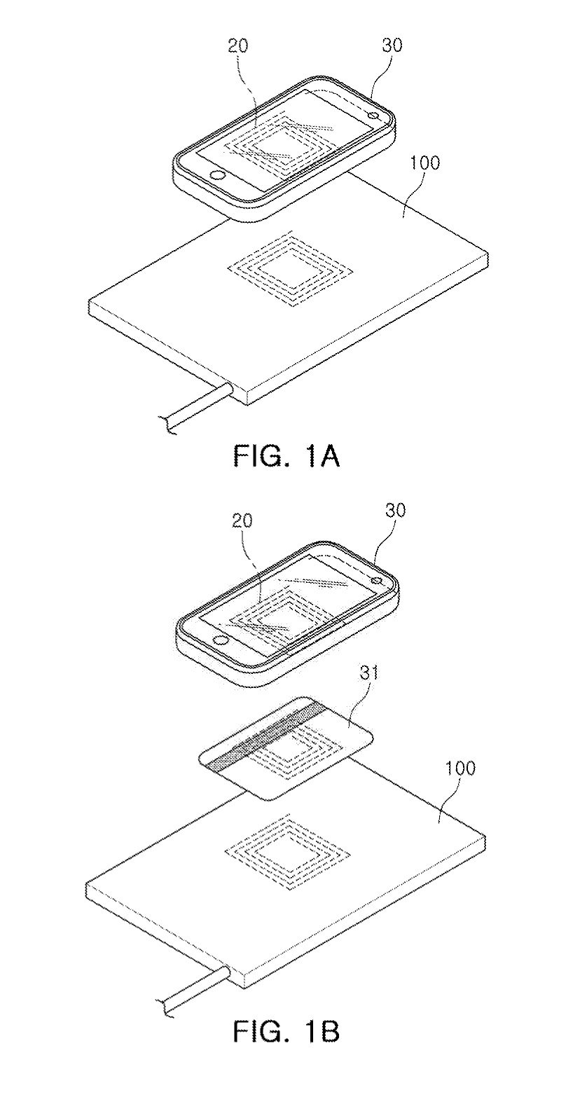

FIG. 1A is a view illustrating an example of an apparatus for transmitting power wirelessly.

In FIG. 1A, an apparatus for transmitting power wirelessly 100 wirelessly transmits power to an apparatus for receiving power wirelessly 20. In one example, the apparatus for transmitting power wirelessly 100 includes a transmission coil. The apparatus for transmitting power wirelessly 100 is magnetically coupled to a receiving coil of the apparatus for receiving power wirelessly 20, and wirelessly transmits power to the apparatus for receiving power wirelessly 20.

The apparatus for receiving power wirelessly 20 is connected to or integrated with an electronic device 30. The apparatus for receiving power wirelessly 20 charges a battery of the electronic device 30 using power supplied from the apparatus for transmitting power wirelessly 100.

The apparatus for transmitting power wirelessly 100 may not only wirelessly transmit power to the apparatus for receiving power wirelessly 20, but may also wirelessly supply power to other devices, such as a wireless tag, or perform wireless communications.

In other words, in addition to wirelessly transmitting power to the apparatus for receiving power wirelessly 20 to charge the apparatus for receiving power wirelessly 20, the apparatus for transmitting power wirelessly 100 may also wirelessly transmit or receive power or information to or from other apparatuses.

In this case, transmitting power wirelessly to the apparatus for receiving power wirelessly 20 to charge the apparatus for receiving power wirelessly 20 is performed using a higher power than power used in wirelessly transmitting or receiving power or information to or from other devices.

In this application, a signal transmitted by the apparatus for transmitting power wirelessly 100 to wirelessly transmit power to the apparatus for receiving power wirelessly 20 is referred to as a “high power transmission signal.” In addition, a signal used by the apparatus for transmitting power wirelessly 100 to wirelessly transmit low power or information to other devices, such as a wireless tag, is referred to as a “low power transmission signal.”

In other words, the high power transmission signal is a signal used by the apparatus for transmitting power wirelessly 100 to wirelessly transmit power to the apparatus for receiving power wirelessly 20. The high power transmission signal includes a short beacon signal or an analog ping signal for detecting a foreign object, or a long beacon signal or a digital ping signal for determining the existence of an apparatus for receiving power wirelessly 20, in addition to a power transmission signal for wirelessly transmitting power.

In addition, the low power transmission signal includes a signal used by the apparatus for transmitting power wirelessly 100 to transmit power or information to a wireless tag, such as a near-field communications (NFC) card.

FIG. 1B is a view illustrating another example of an apparatus for transmitting power wirelessly.

In the example illustrated in FIG. 1B, a wireless tag 31 is disposed adjacent to the apparatus for transmitting power wirelessly 100 in addition to the apparatus for receiving power wirelessly 20 and the electronic device 30. FIG. 1B illustrates the various components spaced apart from each other in a vertical direction for convenience of illustration. However, the electronic device 30 and the wireless tag 31 may also be disposed on the apparatus for transmitting power wirelessly 100.

The wireless tag 31 includes a coil enabling the wireless tag 31 to wirelessly communicate or receive power. In the example illustrated in FIG. 1B, the wireless tag 31 is illustrated as a magnetic card allowing for contactless communications. However, the wireless tag 31 may be any other type of wireless tag, such as an NFC card or a radio frequency identification (RFID) tag.

As illustrated in FIG. 1B, a foreign object, such as the wireless tag 31, may be present on the apparatus for transmitting power wirelessly 100 along with the apparatus for receiving power wirelessly 20. In this case, in a case in which the apparatus for transmitting power wirelessly 100 does not recognize the foreign object and tries to wirelessly transmit power to the apparatus for receiving power wirelessly 20 using the high power transmission signal, the foreign object may be damaged by the high power transmission signal, or power may not be supplied properly to the apparatus for receiving power wirelessly 20.

Thus, it is desirable that the apparatus for transmitting power wirelessly 100 detect the foreign object.

The apparatus for transmitting power wirelessly 100 detects a foreign object using a method of detecting an impedance change of a transmission coil. It is easy to detect a foreign object such as a coin or gold leaf using this method. However, in the case of an electronic tag, a current change generated in the transmission coil of the apparatus for transmitting power wirelessly 100 by the presence of the foreign object is minimal, making it difficult to detect the foreign object.

Thus, the apparatus for transmitting power wirelessly 100 detects the electronic tag using the low power transmission signal. In one example, the low power transmission signal is provided as a wireless tag detection signal for detecting the electronic tag according to a communications method of the electronic tag.

In addition, the apparatus for transmitting power wirelessly 100 transmits the high power transmission signal or the low power transmission signal using a single transmission coil. In other words, the single transmission coil receives either the high power transmission signal or the low power transmission signal to form a magnetic field.

Since the high power transmission signal or the low power transmission signal is transmitted using a single coil, an effect of interference between different coils, which may occur when the signals are transmitted using a plurality of coils as in the related art, can be prevented. Thus, a transmission efficiency is improved, and miniaturization and price reduction of the apparatus for transmitting power wirelessly 100 is achieved.

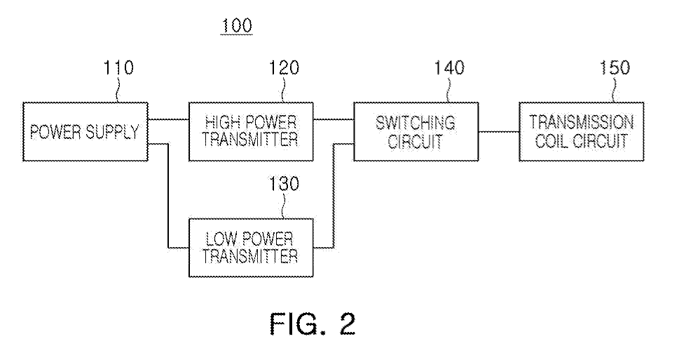

FIG. 2 is a block diagram illustrating an example of an apparatus for transmitting power wirelessly.

Referring to FIG. 2, an apparatus for transmitting power wirelessly 100 includes a high power transmitter 120, a low power transmitter 130, a switching circuit 140, and a transmission coil circuit 150, and in the example illustrated in FIG. 2, further includes a power supply 110. However, the power supply 110 may not be part of the apparatus for transmitting power wirelessly 100, but may be an external power supply.

In one example, the power supply 110 generates direct current (DC) power. In detail, the power supply 110 is a power that receives commercial alternating current (AC) power and outputs DC power having a predetermined level of power.

The high power transmitter 120 generates and outputs a high power transmission signal.

In the example illustrated above, the high power transmission signal includes all signals used to wirelessly transmit power. For example, the high power transmission signal includes a detection signal, such as a short beacon signal or a long beacon signal, for detecting the presence of an apparatus for receiving power wirelessly, and a power transmission signal for wirelessly transmitting power.

The low power transmitter 130 generates and outputs a low power transmission signal.

The low power transmission signal is used to transmit power lower than the power of the high power transmission signal. In detail, the low power transmission signal includes, for example, a communications signal for communicating with an NFC card, or a power signal for providing low power to a wireless tag.

The transmission coil circuit 150 includes a single transmission coil having a plurality of windings. In other words, the transmission coil circuit 150 includes a single transmission coil, rather than a plurality of transmission coils, and may further include a capacitor to form a resonant circuit with the single transmission coil.

The switching circuit 140 electrically connects either the high power transmitter 120 or the low power transmitter 130 to the transmission coil circuit 150 so that either the high power transmission signal or the low power transmission signal is supplied to the transmission coil in response to operations of the high power transmitter 120 and the low power transmitter 130. Thus, the switching circuit 140 operates as an access controller for controlling access to the transmission coil circuit 150 by the high power transmitter 120 and the low power transmitter 130.

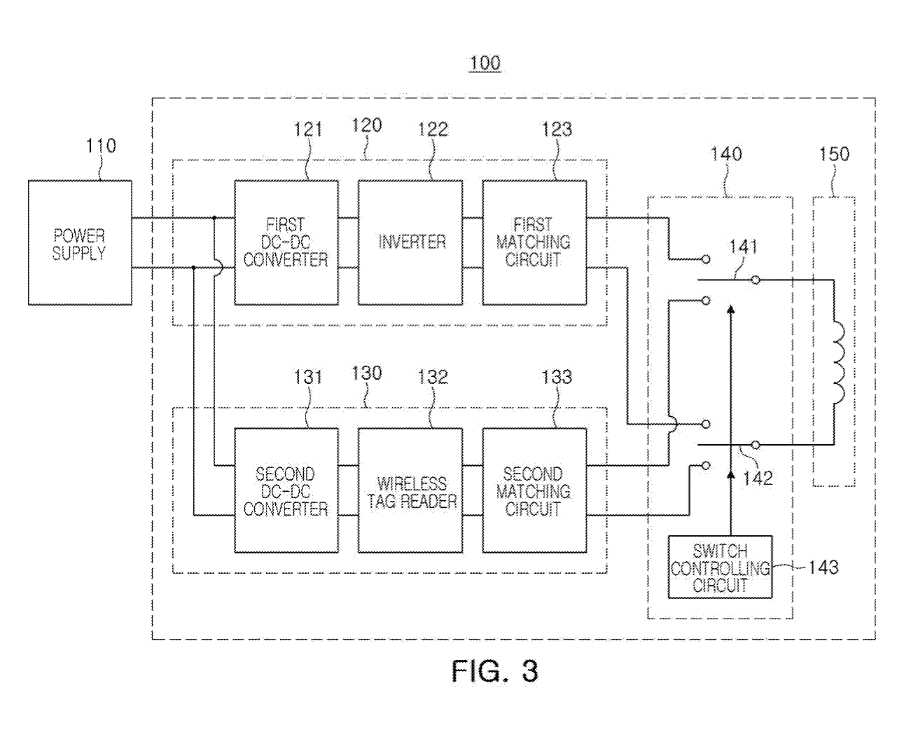

FIG. 3 is a block diagram illustrating an example of the apparatus for transmitting power wirelessly 100 illustrated in FIG. 2.

Referring to FIG. 3, the apparatus for transmitting power wirelessly 100 includes a high power transmitter 120, a low power transmitter 130, a switching circuit 140, and a transmission coil circuit 150, and in the example illustrated in FIG. 3, further includes a power supply 110. However, the power supply 110 may not be part of the apparatus for transmitting power wirelessly 100, but may be an external power supply.

The high power transmitter 120 transmits the high power transmission signal through the transmission coil circuit 150.

In detail, the high power transmitter 120 wirelessly transmits power. In this case, the high power transmitter 120 transmits any one or any combination of any two or more of a foreign object detection signal for detecting a foreign object, a determination signal for determining whether the foreign object is an apparatus for receiving power wirelessly, and a power transmission signal for wirelessly transmitting power to the apparatus for transmitting power wirelessly as the high power transmission signal.

The high power transmitter 120 includes a first DC-DC converter 121, an inverter 122, and a high power transmission controller (not illustrated), and in the example illustrated FIG. 3, further includes a first matching circuit 123.

The first DC-DC converter 121 boosts a DC voltage provided by the power supply 110, and the inverter 122 performs a switching operation on the boosted DC voltage output by the first DC-DC converter 121 to generate an AC voltage, and supplies the AC voltage to the receiving coil circuit 150. Thus, an AC current flows in the transmission coil circuit 150, and the transmission coil circuit 150 forms a magnetic field, thereby wirelessly supplying power to the apparatus for receiving power wirelessly.

The high power transmission controller (not illustrated) controls an operation of either one or both of the first DC-DC converter 121 and the inverter 122.

In one example, the high power transmission controller (not illustrated) controls the inverter 122 to periodically transmit the foreign object detection signal. The high power transmission controller (not illustrated) determines whether a foreign object is present in the vicinity of the apparatus for transmitting power wirelessly based on a state change, such as an impedance change, of the transmission coil circuit 150 transmitting the foreign object detection signal. In a case in which it is determined that a foreign object is present, the high power transmission controller (not illustrated) determines whether the foreign object is an apparatus for receiving power wirelessly. Subsequently, in a case in which the foreign object is determined to be the apparatus for receiving power wirelessly, the high power transmission controller controls the inverter 122 to enable the apparatus for receiving power wirelessly to wirelessly receive power.

Alternatively, in a case in which it is determined that the foreign object is not the apparatus for receiving power wirelessly, the high power transmission controller (not illustrated) performs a foreign object detection control. In detail, the foreign object detection control may be performed in various ways depending on the situation. For example, while power is being wirelessly transmitted, the foreign object detection control may immediately stop wirelessly transmitting power or stop a preparation process for wirelessly transmitting power and provide a notification that a foreign object has been detected.

The low power transmitter 130 transmits a low power transmission signal through the transmission coil circuit 150.

In one example, the low power transmitter 130 may be a wireless tag reader for recognizing a wireless tag, such as an NFC card. In this example, the low power transmission signal includes a wireless tag detection signal for reading the wireless tag.

The low power transmitter 130 includes a second DC-DC converter 131 and a wireless tag reader 132, and in the example illustrated in FIG. 3, further includes a second matching circuit 133.

The second DC-DC converter 131 receives and transforms a DC voltage supplied by the power supply 110. In one example, the second DC-DC converter 131 steps down a DC voltage supplied by the power supply 110.

The wireless tag reader 132 performs an operation for wirelessly communicating with the wireless tag, that is, an operation for reading the wireless tag, using the stepped-down DC voltage output by the second DC-DC converter 131.

The wireless tag reader 132 performs a detection operation to determine whether a wireless tag is present in a region in which communications are possible. When the wireless tag is detected, the wireless tag reader 132 notifies the high power transmission controller (not illustrated). In response, the high power transmission controller (not illustrated) performs the foreign object detection control, such as interruption of wireless power transmission and notification that a foreign object has been detected.

The switching circuit 140 electrically connects either the high power transmitter 120 or the low power transmitter 130 to the transmission coil circuit 150 in response to operations of the high power transmitter 120 and the low power transmitter 130.

The switching circuit 140 includes a first switch 141, a second switch 142, and a switch controlling circuit 143.

The first switch 141 and the second switch 142 perform switching operations so that either an output of the high power transmitter 120 or an output of the low power transmitter 130 is supplied to the transmission coil circuit 150. Thus, the switching circuit 140 operates as an access controller for controlling access to the transmission coil circuit 150 by the high power transmitter 120 and the low power transmitter 130.

The switch controlling circuit 143 controls switching operations of the first switch 141 and the second switch 142.

In one example, the switch controlling circuit 143 receives control information output by the high power transmission controller (not illustrated) and the wireless tag reader 132, and controls the switching operations of the first switch 141 and the second switch 142 in accordance with the control information.

In another example, the switch controlling circuit 143 controls the switching operations of the first switch 141 and the second switch 142 so that the first switch 141 and the second switch 142 are operated according to a predetermined schedule. Subsequently, the switch controlling circuit 143 controls the switching operations of the first switch 141 and the second switch 142 according to control information provided from the high power transmission controller (not illustrated) and the wireless tag reader 132.

In one example, while the high power transmitter 120 transmits the foreign object detection signal, and the low power transmitter 130 transmits the wireless tag detection signal, the switch controlling circuit 143 controls the switches 141 and 142 so that the high power transmitter 120 and the low power transmitter 130 are alternately connected to the transmission coil circuit 150.

In one example, the switch controlling circuit 143 electrically connects the transmission coil circuit 150 to the low power transmitter 130 while the wireless tag is determined to be present by the wireless tag detection signal to prevent the wireless tag from being damaged by not wirelessly transmitting the high power transmission signal while the wireless tag is being detected.

The transmission coil circuit 150 wirelessly transmits the high power transmission signal or the low power transmission signal. In one example, the transmission coil circuit 150 includes a resonant capacitor to form a resonant circuit together with the transmission coil.

In the example described above, a component performing control, such as the high power transmission controller (not illustrated), the wireless tag reader 132, or the switch controlling circuit 143, may be implemented by a processor. The processor may be a central processing unit (CPU), a graphics processing unit (GPU), a microprocessor, an application-specific integrated circuit (ASIC), a field-programmable gate array (FPGA), or any other type of processor, and may have a plurality of cores. The components described above may further include a memory, such as either one or both of a volatile memory, such as a random-access memory (RAM), and a nonvolatile memory, such as a read-only memory (ROM) or a flash memory, according to need.

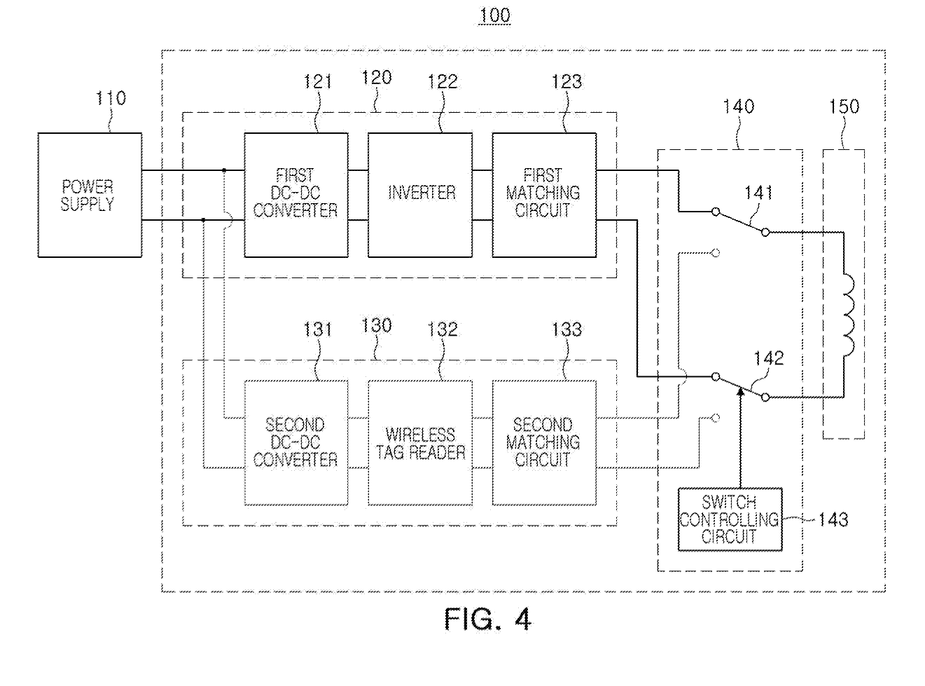

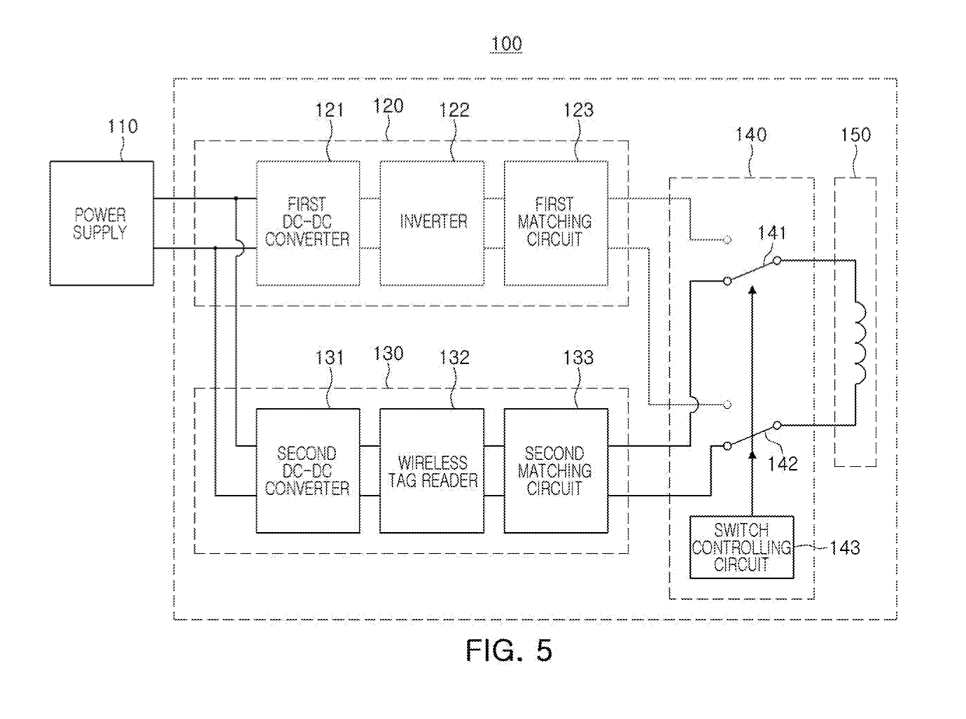

FIG. 4 is a block diagram illustrating an example of a first operation of the apparatus for transmitting power wirelessly illustrated in FIG. 3, and FIG. 5 is a block diagram illustrating an example of a second operation of the apparatus for transmitting power wirelessly illustrated in FIG. 3.

In FIG. 4, the switch controlling circuit 143 controls the first switch 141 and the second switch 142 so that an output of the high power transmitter 120 is supplied to the transmission coil circuit 150. When a current path is formed as illustrated in FIG. 4, an AC current is applied to opposite ends of the single transmission coil of the transmission coil circuit 150. Thus, a magnetic field is formed, thereby transmitting a foreign object detection signal or wirelessly transmitting power.

On the other hand, in FIG. 5, the switch controlling circuit 143 controls the first switch 141 and the second switch 142 so that an output of the low power transmitter 130 is supplied to the transmission coil circuit 150. When a current path is formed as illustrated in FIG. 5, a current is applied to the transmission coil circuit 150 according to an operation of the wireless tag reader 132, thereby communicating with the wireless tag.

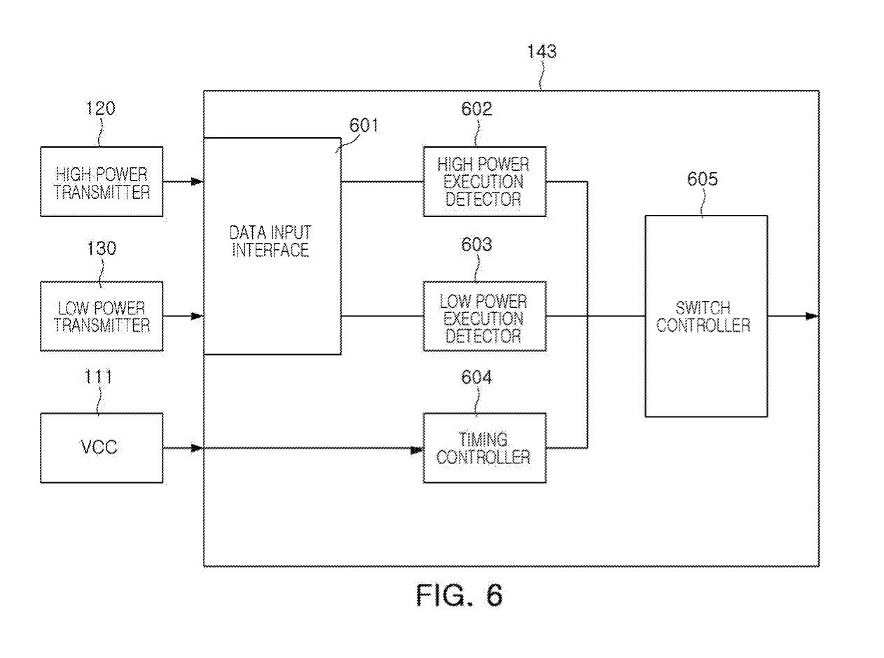

FIG. 6 is a block diagram illustrating an example of the switch controlling circuit 143 illustrated in FIG. 3.

Referring to FIG. 6, the switch controlling circuit 143 includes a data input interface 601, a high power execution detector 602, a low power execution detector 603, and a switch controller 605, and in the example illustrated in FIG. 6, further includes a timing controller 604.

The data input interface 601 receives data on operations of a high power transmitter 120 and a low power transmitter 130 from the high power transmitter 120 and the low power transmitter 130.

The high power execution detector 602 detects an execution state of the high power transmitter 120 from the data on the operations of the high power transmitter 120 described above.

In one example, the high power execution detector 602 checks a status of a foreign object detection signal or a determination signal transmitted from the high power transmitter 120 or an impedance of the transmission coil circuit 150, thereby determining the execution state of the high power transmitter 120.

The low power execution detector 603 detects an execution state of the low power transmitter 130 from the data on the operation of the low power transmitter 130.

In one example, the low power execution detector 603 determines whether the low power transmitter 130 is in a state ready to detect a wireless tag or in a state in which the wireless tag has been detected based on information regarding a wireless tag detection signal.

The switch controller 605 controls the switches 141 and 142 illustrated in FIG. 3 to connect either the high power transmitter 120 or the low power transmitter 130 to the transmission coil circuit 150 in response to outputs of the high power execution detector 602 and the low power execution detector 603, that is, the execution states of the high power transmitter 120 and the low power transmitter 130.

The timing controller 604 generates and provides information regarding switching timing, while the switch controller 605 performs a switching control operation based on the information regarding switching timing.

In one example, the switch controller 605 controls the switches 141 and 142 so that the high power transmitter 120 and the low power transmitter 130 are alternately connected to the transmission coil circuit 150. For example, in a case in which both the high power transmitter 120 and the low power transmitter 130 transmit a detection signal, the switch controller controls the switches 141 and 142 to alternately transmit the detection signals.

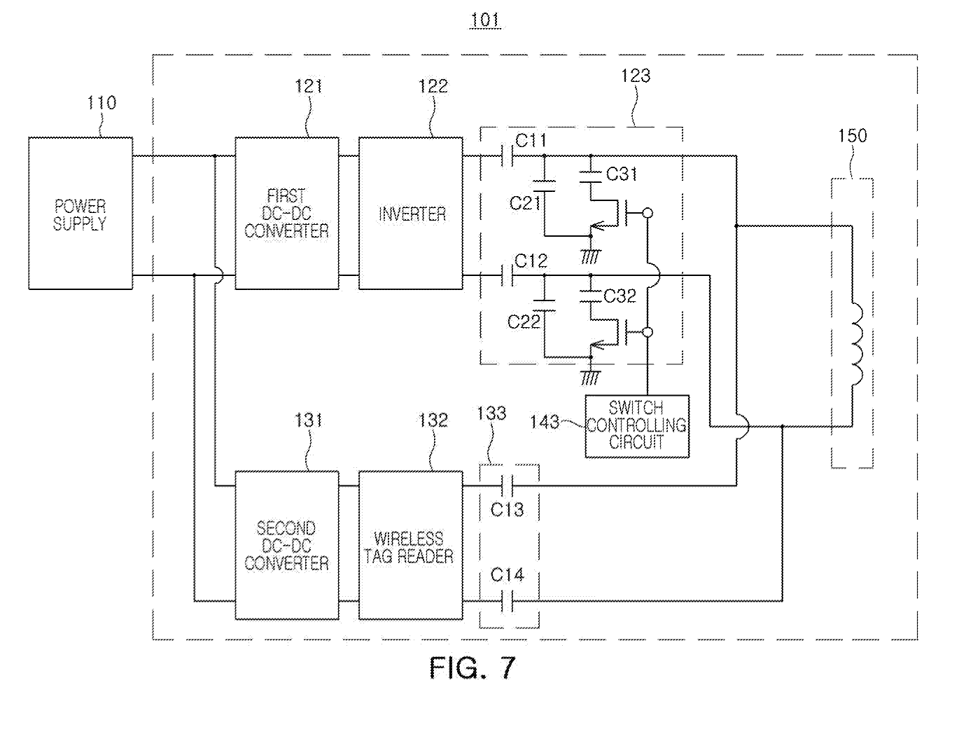

FIG. 7 is a block diagram illustrating another example of the apparatus for transmitting power wirelessly illustrated in FIG. 2. The example illustrated in FIG. 7 is an example in which the first matching circuit 123 includes switches.

Referring to FIG. 7, a high power transmitter includes a first matching circuit 123. The first matching circuit 123 is connected between output terminals of the inverter 122 and the single transmission coil of the transmission coil circuit 150, and includes at least one capacitor. The at least one capacitor and the single transmission coil of the transmission coil circuit 150 form a resonant circuit.

In the example illustrated in FIG. 7, the first matching circuit 123 includes first capacitors C11 and C12, first ends of which are connected to the output terminals of the inverter 122, and second ends of which are connected to the single transmission coil of the transmission coil circuit 150. The first matching circuit 123 further includes second capacitors C21 and C22 and third capacitors C31 and C32, first ends of which are connected to the second ends of the first capacitors C11 and C12. Second ends of the second capacitors C21 and C22 are grounded, while second ends of the third capacitors C31 and C32 are grounded through respective switches.

The switch controlling circuit 143 controls operations of the switches included in the first matching circuit 123, thereby controlling switching between the high power transmitter and the transmission coil circuit 150.

A resonant frequency when high power is transmitted may be lower than a resonant frequency when low power is transmitted. In one example, the resonant frequency when high power is transmitted is 6.78 MHz, while the resonant frequency when low power is transmitted is 13.56 MHz. In the example illustrated in FIG. 7, the switch controlling circuit 143 turns on the switches in the first matching circuit 123 connecting capacitors C31 and C32 to ground when high power is transmitted, thereby connecting capacitors C21 and C31 in parallel and connecting capacitors C22 and C32 in parallel to increase the capacitance of the first matching circuit 123, thereby reducing the resonant frequency of the transmission coil circuit 150. In contrast, the switch controlling circuit 143 turns off the switches in the first matching circuit 123 connecting capacitors C31 and C32 to ground when low power is transmitted so that capacitors C21 and C31 are not connected in parallel and capacitors C22 and C32 are not connected in parallel to decrease the capacitance of the first matching circuit 123, thereby increasing the resonant frequency of the transmission coil circuit 150. In other words, the resonant frequency of the transmission coil circuit 150 is determined by the total capacitance of the first matching circuit 123 and the second matching circuit 133 that are connected to the transmission coil circuit 150 in parallel. Thus, even in the case in which the wireless tag reader 132 is operated to transmit low power, if the capacitance of the first matching circuit 123 is reduced, the total capacitance connected to the transmission coil circuit 150 is reduced, thereby increasing the resonant frequency of the transmission coil circuit 150.

In contrast, the second matching circuit 133 includes only matching capacitors C13 and C14 without switches. However, in another example, the second matching circuit 133 also includes switches (not illustrated). In this case, the switch controlling circuit 143 also controls the switches included in the second matching circuit 133, thereby controlling the switching between a low power transmitter and the transmission coil circuit 150. In this other example, both the first matching circuit 123 and the second matching circuit 133 include switches. However, in still another example, only the second matching circuit 133 includes switches.

In the examples of the apparatus for transmitting power wirelessly 100 described with reference to FIGS. 2 to 7, the switch controlling circuit 143 included in the switching circuit 140 controls the switches 141 and 142 included in the switching circuit 140, or the switches (if any) included in the first matching circuit 123 and the switches (not illustrated) (if any) included in the second matching circuit 133, to control whether the high power transmitter 120 or the low power transmitter 130 is connected to a single transmission coil. Thus, the switching circuit 140 and the switching controlling circuit 143, or the first matching circuit 123 and the switching controlling circuit 143, or the second matching circuit 133 and the switching controlling circuit 143, or the first matching circuit 123, the second matching circuit 133, and the switching controlling circuit 143, operate as an access controller for controlling access to the transmission coil circuit 150 by the high power transmitter 120 and the low power transmitter 130.

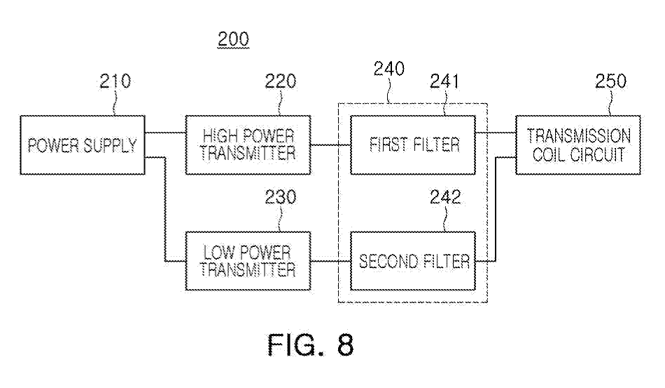

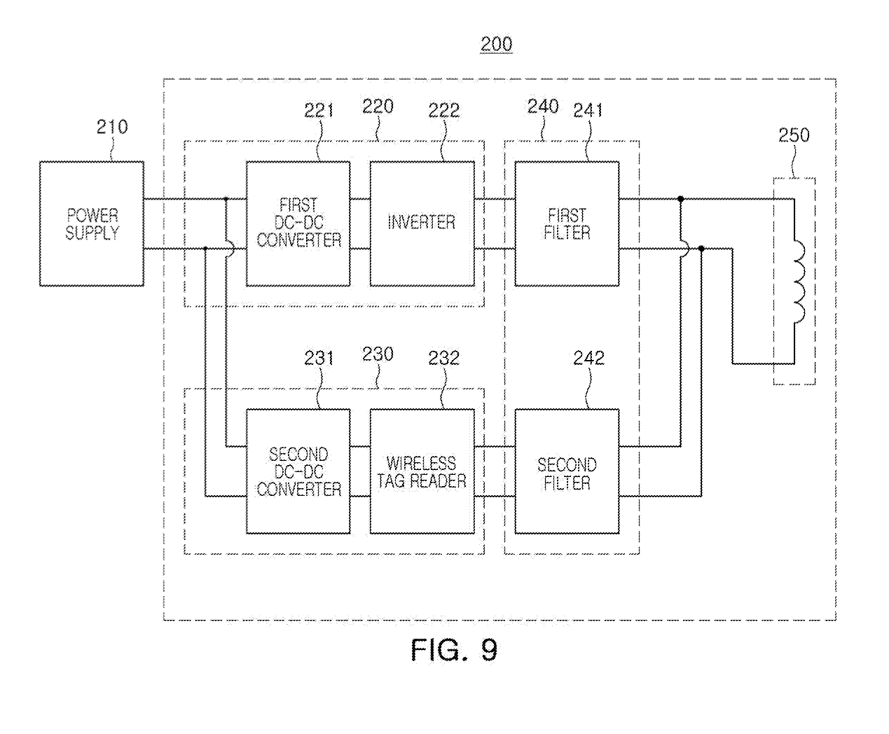

In another example, an apparatus for transmitting power wirelessly uses a filter instead of the switches controlled by the switch controlling circuit 143, thereby allowing a single transmission coil to be used by the high power transmitter 120 and the low power transmitter 130. A more detailed description will be provided with reference to FIGS. 8 and 9.

FIG. 8 is a block diagram illustrating another example of an apparatus for transmitting power wirelessly.

Referring to FIG. 8, an apparatus for transmitting power wirelessly 200 includes a high power transmitter 220, a low power transmitter 230, a filter circuit 240, and a transmission coil circuit 250, and in the example illustrated in FIG. 8, further includes a power supply 210. However, the power supply 210 may not be part of the apparatus for transmitting power wirelessly 200, but may be an external power supply.

The descriptions of the power supply 110, the high power transmitter 120, the low power transmitter 130, and the transmission coil circuit 150 illustrated in FIGS. 2 and 3 are also applicable to the power supply 210, the high power transmitter 220, the low power transmitter 230, and the transmission coil circuit 250 illustrated in FIGS. 8 and 9, and accordingly these descriptions have not been repeated here.

The filter circuit 240 includes a first filter 241 and a second filter 242.

The first filter 241 is interposed between the high power transmitter 220 and the transmission coil circuit 250, and blocks signals having frequencies outside a frequency range of a high power transmission signal output from the high power transmitter 220.

The second filter 242 is interposed between the low power transmitter 230 and the transmission coil circuit 250, and blocks signals having frequencies outside a frequency range of a low power transmission signal output from the low power transmitter 230.

In detail, in a case in which the high power transmitter 220 is operated, the high power transmission signal output by the high power transmitter 220 is supplied to the transmission coil circuit 250 through the first filter 241. The frequency range of the high power transmission signal is outside the frequency range of the low power transmission signal, and thus the high power transmission signal is blocked by the second filter 242 so that the high power transmission signal is not input into the low power transmitter 230.

On the other hand, in a case in which the low power transmitter 230 is operated, the low power transmission signal output by the low power transmitter 230 is supplied to the transmission coil circuit 250 through the second filter 242. The frequency of the low power transmission signal is outside the frequency range of the high power transmission signal, and thus the low power transmission signal is blocked by the first filter 241 so that the low power transmission signal is not input into the high power transmitter 220.

In the example described above, a switching control of a switching circuit is not needed. However, to prevent the high power transmitter 220 and the low power transmitter 230 from operating simultaneously, simultaneous control prevention of the high power transmitter 220 and the low power transmitter 230 may be performed.

FIG. 9 is a block diagram illustrating an example of the apparatus for transmitting power wirelessly illustrated in FIG. 8.

Referring to FIG. 9, an apparatus for transmitting power wirelessly 200 includes a high power transmitter 220, a low power transmitter 230, a filter circuit 240 including a first filter 241 and a second filter 242, and a transmission coil circuit 250, and in the example illustrated in FIG. 9, further includes a power supply 210. However, the power supply 210 may not be part of the apparatus for transmitting power wirelessly 200, but may be an external power supply.

The high power transmitter 220 includes a first DC-DC converter 221, an inverter 222, and a high power transmission controller (not illustrated), and may further include a first matching circuit (not illustrated). The descriptions of the first DC-DC converter 121, the inverter 122, and the first matching circuit 123 in FIG. 3 are also applicable to the first DC-DC converter 221, the inverter 222, and the first matching circuit (not illustrated) in FIG. 9, and accordingly these descriptions have not been repeated here.

The first filter 241 passes a high power transmission signal output from the inverter 222, and blocks a low power transmission signal output from a wireless tag reader 232.

The high power transmission controller (not illustrated) controls an operation of the inverter 222 to prevent the inverter 222 from operating simultaneously with the wireless tag reader 232.

In one example, the high power transmission controller (not illustrated) is set to operate during a time period during which the wireless tag reader 232 is not set to operate.

In another example, the high power transmission controller (not illustrated) has priority over the use of the transmission coil circuit 250. Thus, in a case in which the high power transmission controller (not illustrated) provides information indicating that the high power transmission controller (not illustrated) is not operating to the wireless tag reader 232, the wireless tag reader 232 may be operated.

Thus, the high power transmission controller (not illustrated) operates as an access controller for controlling access to the transmission coil circuit 250 by the high power transmitter 220 and the low power transmitter 230.

The low power transmitter 230 includes a second DC-DC converter 231 and the wireless tag reader 232, and may further include a second matching circuit (not illustrated). The descriptions of the second DC-DC converter 131, the wireless tag reader 132, and the second matching circuit 133 in FIG. 3 are also applicable to the second DC-DC converter 231, the wireless tag reader 232, and the second matching circuit (not illustrated) in FIG. 9, and accordingly these descriptions have not been repeated here.

The second filter 242 passes the low power transmission signal output from the wireless tag reader 232, and blocks the high power transmission signal output from the inverter 222.

As illustrated in the example described above, the wireless tag reader 232 and the high power transmission controller (not illustrated) are not operated simultaneously.

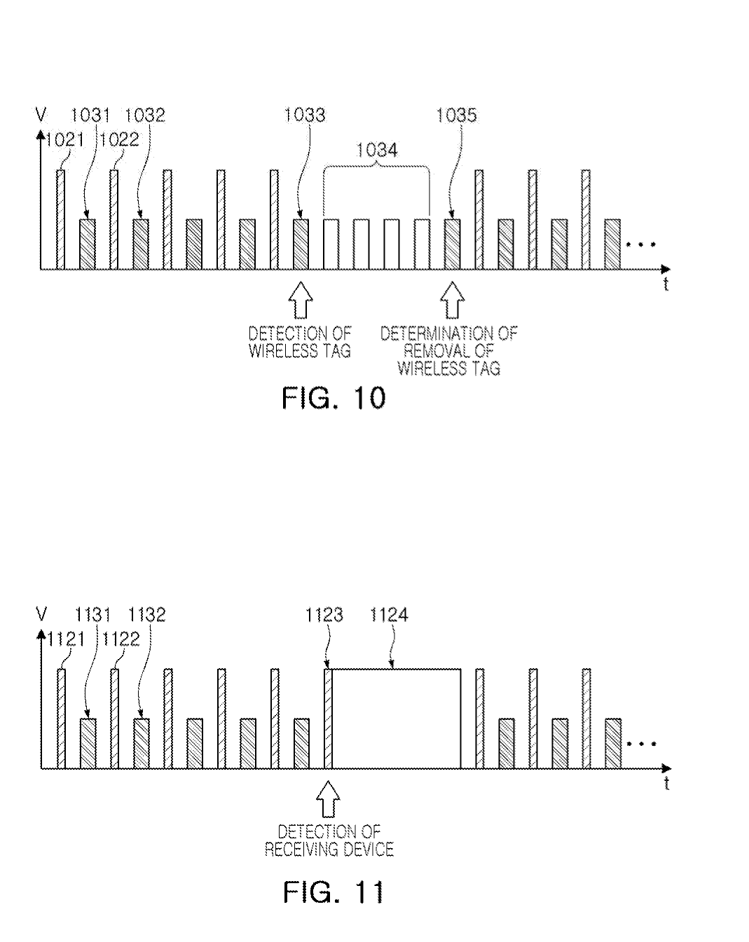

FIGS. 10 to 12 are views illustrating examples of a transmission signal of an apparatus for transmitting power wirelessly.

The example illustrated in FIG. 10 illustrates an example in which the apparatus for transmitting power wirelessly 100 detects a wireless tag and performs a foreign object detection control operation.

Referring to FIG. 10, the apparatus for transmitting power wirelessly 100 transmits first detection signals 1021 and 1022, which are high power transmission signals for detecting an apparatus for receiving power wirelessly, and transmits second detection signals 1031 to 1034, which are low power transmission signals for detecting a wireless tag.

FIG. 10 illustrates one example in which a first detection signal and a second detection signal are alternately transmitted. In the example illustrated in FIG. 10, the periods of the first detection signal and the second detection signal are different, but they may be the same.

In a case in which the wireless tag is detected by the second detection signal 1033 after the first detection signals 1021 and 1022 and the second detection signals 1031 and 1032 are transmitted, the apparatus for transmitting power wirelessly performs the foreign object detection control.

As illustrated in FIG. 10, the apparatus for transmitting power wirelessly periodically transmits only a second detection signal 1034 until a removal of the wireless tag is detected. In a case in which the removal of the wireless tag is detected by the second detection signal 1035, the apparatus for transmitting power wirelessly once again alternately transmits the first detection signal and the second detection signal.

FIG. 11 illustrates an example in which the apparatus for transmitting power wirelessly detects the apparatus for receiving power wirelessly and controls wireless transmission of power.

Referring to FIG. 11, the apparatus for transmitting power wirelessly transmits first detection signals 1121 to 1123, which are high power transmission signals for detecting the apparatus for receiving power wirelessly, and transmits second detection signals 1131 and 1132, which are low power transmission signals for detecting the wireless tag.

In the meantime, in a case in which a foreign object is detected by the first detection signal 1123 when the first detection signals 1121 to 1123 and the second detection signals 1131 and 1132 are being alternately transmitted, the apparatus for transmitting power wirelessly determines whether or not the foreign object is the apparatus for receiving power wirelessly. In a case in which the foreign object is determined to be the apparatus for receiving power wirelessly, the apparatus for transmitting power wirelessly transmits a power transmission signal 1124, and wirelessly transmits power to the apparatus for receiving power wirelessly.

Subsequently, in a case in which power transmission is completed, the apparatus for transmitting power wirelessly once again alternately transmits the first detection signal and the second detection signal.

FIGS. 10 and 11 illustrate examples in which the first detection signal, which is a high power transmission signal, and the second detection signal, which is a low power transmission signal, are uniformly transmitted. For example, the high power detection signal and the low power detection signal are transmitted an equal number of times.

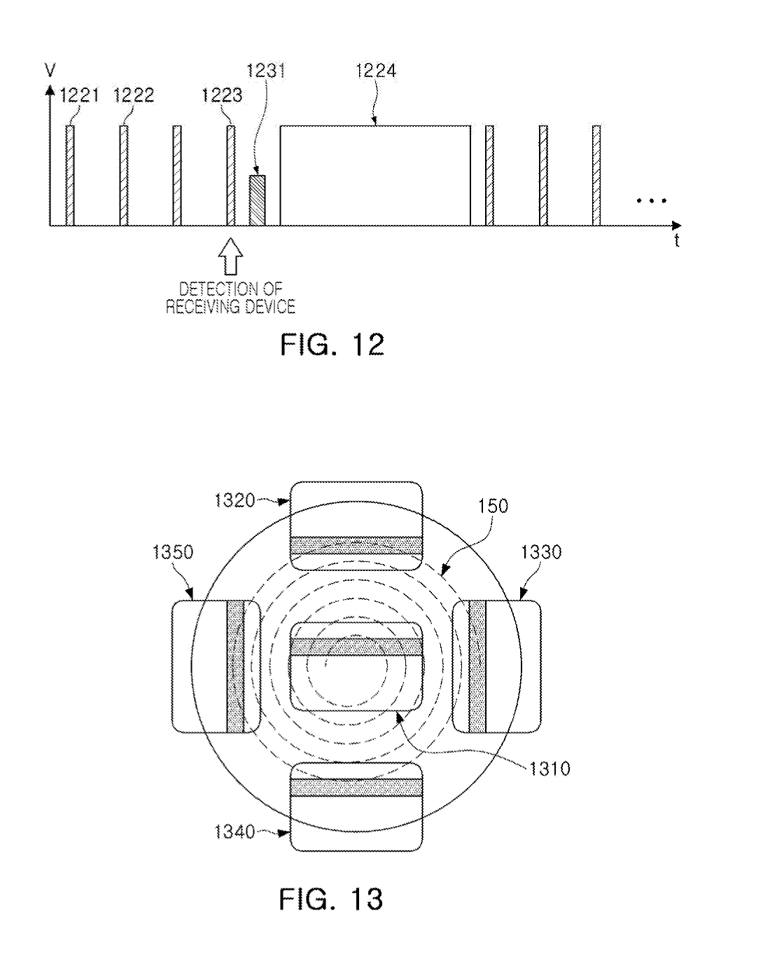

In another example, the apparatus for transmitting power wirelessly sets transmission of the first detection signal and the second detection signal differently as illustrated in FIG. 12. For example, the high power detection signal and the low power detection signal are transmitted an unequal number of times.

Referring to FIG. 12, the apparatus for transmitting power wirelessly transmits only first detection signals 1221 to 1223, which are high power transmission signals for detecting the apparatus for receiving power wirelessly.

Subsequently, in a case in which the foreign object is detected by the first detection signal 1223, and is determined to be the apparatus for receiving power wirelessly, the apparatus for transmitting power wirelessly transmits a second detection signal 1231, which is a low power transmission signal, to determine whether the wireless tag is present before transmitting a power transmission signal to wirelessly transmit power.

Since the first detection signal 1223 for detecting the foreign object is transmitted only for a relatively short time, the first detection signal 1223 does not cause damage to the wireless tag. However, the power transmission signal 1224 wirelessly transmitting power causes damage to the wireless tag. In other words, before the apparatus for transmitting power wirelessly transmits the power transmission signal 1224 that causes damage to the wireless tag, the apparatus for transmitting power wirelessly transmits the second detection signal 1231, which is the low power transmission signal, to determine whether the wireless tag is present before transmitting the power transmission signal 1224 to wirelessly transmit power. If the apparatus for transmitting power wirelessly determines that the wireless tag is present based on the second detection signal 1231, the apparatus for transmitting power wirelessly does not transmit the power transmission signal 1224 as long as the wireless tag is present. In other words, the apparatus for transmitting power wirelessly prevents the high power transmitter of the apparatus for transmitting power wirelessly from accessing the transmission coil circuit as long as the wireless tag is present.

FIG. 13 is a view illustrating an example in which a wireless tag is placed at different positions 1310 to 1350 on an apparatus for transmitting power wirelessly.

In the examples described above, the apparatus for transmitting power wirelessly transmits two different power signals using a single transmission coil.

In other words, since the apparatus for transmitting power wirelessly uses a single coil covering a relatively large area, the apparatus for transmitting power wirelessly has a relatively high recognition rate of the wireless tag compared to a case of using separate coils.

In other words, as illustrated in FIG. 13, since the wireless tag is detected using a single transmission coil in the transmission coil circuit 150, accurate recognition of a position of the wireless tag is possible, even though the wireless tag is disposed at the various positions 1310 to 1350.

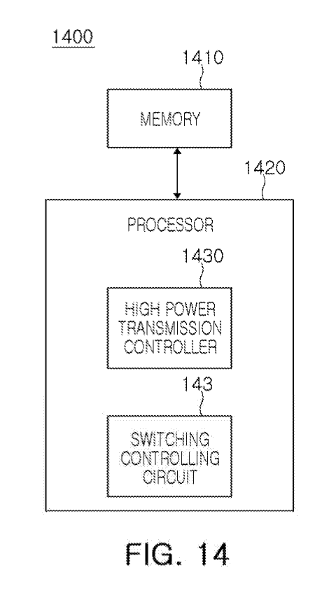

FIG. 14 illustrates an example of a block diagram of a controller of an apparatus for transmitting power wirelessly.

Referring to FIG. 14, a controller 1400 includes a memory 1410 and a processor 1420. The memory 1410 stores instructions that, when executed by the processor 1420, cause the processor 1420 to perform the functions of a high power transmission controller 1430 and the switch controlling circuit 143 illustrated in FIGS. 3-7, and also cause the processor 1420 to perform the methods illustrated in FIGS. 10-12. The high power transmission controller 1430 is the unillustrated high power transmission controller in the examples of the apparatus for transmitting power wirelessly illustrated in FIGS. 3-7 and 9.

The instructions stored in the memory 1410, when executed by the processor 1420, cause the processor 1420 to perform the functions of the data input interface 601, the high power execution detector 602, the low power execution detector 603, the timing controller 604, and the switch controller 605 of the switch controlling circuit 143 illustrated in FIG. 6.

In the examples described above, an apparatus for transmitting power wirelessly has a reduced number of components, thereby miniaturizing the apparatus for transmitting power wirelessly and reducing material costs thereof.

In addition, the apparatus for transmitting power wirelessly has an increased recognition rate of a wireless tag, such as a credit card, thereby preventing the wireless tag from being damaged.

Furthermore, the apparatus for transmitting power wirelessly precisely controls transmission of a detection signal, thereby preventing a waste of power, overheating of the apparatus for transmitting power wirelessly, damage to elements thereof, and other problems.

The high power transmission controller in the examples illustrated in FIGS. 3-7 and 14 (which is unillustrated in FIGS. 3-7) and the switch controlling circuit 143 in the examples illustrated in FIGS. 3-7, 9, and 14 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 10-12 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An apparatus for transmitting power wirelessly comprising:
a transmission coil circuit comprising a single coil comprising a plurality of turns;
a high power transmitter configured to transmit a high power transmission signal for transmitting first power through the transmission coil circuit;
a low power transmitter configured to transmit a low power transmission signal for transmitting second power lower than the first power through the transmission coil circuit; and
a switching circuit configured to electrically connect either the high power transmitter or the low power transmitter to the transmission coil circuit in response to operations of the high power transmitter and the low power transmitter.

2. The apparatus for transmitting power wirelessly of claim 1, wherein the high power transmission signal comprises any one or any combination of any two or more of a foreign object detection signal for detecting a foreign object, a determination signal for determining whether the foreign object is an apparatus for receiving power wirelessly, and a power transmission signal for wirelessly transmitting power to the apparatus for receiving power wirelessly.

3. The apparatus for transmitting power wirelessly of claim 2, wherein the low power transmission signal comprises a wireless tag detection signal for reading a wireless tag.

4. The apparatus for transmitting power wirelessly of claim 3, wherein the switching circuit comprises:
a switch configured to connect the single coil to either the high power transmitter or the low power transmitter; and
a processor configured to control switching of the switch.

5. The apparatus for transmitting power wirelessly of claim 4, further comprising a memory configured to store instructions;
wherein the processor is further configured to execute the instructions to configure the processor to control the switching of the switch.

6. The apparatus for transmitting power wirelessly of claim 4, wherein the processor comprises a switch controlling circuit configured to control the switching of the switch.

7. The apparatus for transmitting power wirelessly of claim 6, wherein the switch controlling circuit is further configured to electrically connect the transmission coil circuit to the low power transmitter in response to the wireless tag being determined to be present by the wireless tag detection signal.

8. The apparatus for transmitting power wirelessly of claim 6, wherein the switch controlling circuit is further configured to control the switch to alternately connect the high power transmitter to the single coil while the high power transmitter transmits the foreign object detection signal, and the low power transmitter to the single coil while the low power transmitter transmits the wireless tag detection signal.

9. The apparatus for transmitting power wirelessly of claim 6, wherein the switch controlling circuit comprises:
a data input interface configured to receive data from the high power transmitter and the low power transmitter;
a high power execution detector configured to detect an execution state of the high power transmitter based on the data;
a low power execution detector configured to detect an execution state of the low power transmitter based on the data; and
a switch controller configured to control the switch to connect either the high power transmitter or the low power transmitter to the single coil in response to the execution state of the high power transmitter and the execution state of the low power transmitter.

10. The apparatus for transmitting power wirelessly of claim 1, wherein the apparatus for transmitting power wirelessly is configured to receive a predetermined level of direct current (DC) power from a power supply;
the high power transmitter comprises a first DC-DC converter configured to boost the DC power; and
the low power transmitter comprises a second DC-DC converter configured to step down the DC power.

11. The apparatus for transmitting power wirelessly of claim 10, wherein the high power transmitter further comprises:
an inverter configured to output alternating current (AC) power by performing a switching operation on an output of the first DC-DC converter; and
a matching circuit connected to an output terminal of the inverter and comprising at least one capacitor; and
the single coil and the at least one capacitor form a resonant circuit.

12. The apparatus for transmitting power wirelessly of claim 11, wherein the matching circuit further comprises at least one switch; and
the switching circuit is further configured to control an operation of the at least one switch to control switching between the high power transmitter and the transmission coil circuit.

13. An apparatus for transmitting power wirelessly comprising:
a transmission coil circuit comprising a single coil comprising a plurality of turns;
a high power transmitter configured to transmit a high power transmission signal for transmitting first power through the transmission coil circuit;
a low power transmitter configured to transmit a low power transmission signal for transmitting second power lower than the first power through the transmission coil circuit;
a first filter connected to an output terminal of the high power transmitter and configured to block signals having frequencies outside a frequency range of the high power transmitter; and
a second filter connected to an output terminal of the low power transmitter and configured to block signals having frequencies outside a frequency range of the low power transmitter.

14. The apparatus for transmitting power wirelessly of claim 13, wherein the high power transmitter comprises:
a first direct current (DC)-DC converter configured to boost DC power received from a power supply;
an inverter configured to output alternating current (AC) power by performing a switching operation on an output of the first DC-DC converter; and
a processor configured to control the switching operation of the inverter.

15. The apparatus for transmitting power wirelessly of claim 14, further comprising a memory configured to store instructions;
wherein the processor is further configured to execute the instructions to configure the processor to control the switching operation of the inverter.

16. The apparatus for transmitting power wirelessly of claim 14, wherein the processor comprises a high power transmission controller configured to control the switching operation of the inverter.

17. The apparatus for transmitting power wirelessly of claim 16, wherein the high power transmission controller is further configured to operate during a period during which the low power transmitter does not operate.

18. The apparatus for transmitting power wirelessly of claim 16, wherein the high power transmission controller is further configured to have operational priority over the transmission coil circuit and provide the low power transmitter with information indicating when the high power transmission controller is not operating.

19. The apparatus for transmitting power wirelessly of claim 14, wherein the low power transmitter comprises a second DC-DC converter configured to step down the DC power.

20. The apparatus for transmitting power wirelessly of claim 13, wherein the high power transmission signal comprises any one or any combination of any two or more of a foreign object detection signal for detecting a foreign object, a determination signal for determining whether the foreign object is an apparatus for receiving power wirelessly, and a power transmission signal for wirelessly transmitting power to the apparatus for receiving power wirelessly; and
the low power transmission signal comprises a wireless tag detection signal for reading a wireless tag.

21. An apparatus for transmitting power wirelessly comprising:
a transmission coil circuit comprising a single coil;
a high power transmitter configured to output a high power transmission signal for transmitting first power through the transmission coil circuit;
a low power transmitter configured to output a low power transmission signal for transmitting second power lower than the first power through the transmission coil circuit; and
an access controller configured to enable only the high power transmitter to access the transmission coil circuit until a predetermined condition occurs.

22. The apparatus for transmitting power wirelessly of claim 21, wherein the predetermined condition is a presence of a foreign object; and
the access controller is further configured to enable only the low power transmitter to access the transmission coil circuit to determine whether the foreign object is a wireless device subject to damage by the high power transmission signal.

23. The apparatus for transmitting power wirelessly of claim 22, wherein the access controller is further configured to prevent the high power transmitter from accessing the transmission coil circuit as long as the foreign object is present in response to a determination that the foreign object is a wireless device subject to damage by the high power transmission signal.

24. The apparatus for transmitting power wirelessly of claim 22, wherein the access controller is further configured to enable only the high power transmitter to access the transmission coil circuit to supply power wirelessly to the foreign object as long as the foreign object is present in response to a determination that the foreign object is not a wireless device subject to damage by the high power transmission signal.
